(19) United States
(12) Patent Application Publication
(10) Pub. No.: US 2016/0249171 A1
(43) Pub. Date: Aug. 25, 2016

(54) OBJECT DISTANCE DETERMINATION SYSTEM

(71) Applicant: Kahin Shemssulldin, Nashville, TN (US)

(72) Inventor: Kahin Shemssulldin, Nashville, TN (US)

(21) Appl. No.: 14/626,537

(22) Filed: Feb. 19, 2015

(51) Int. Cl. H04W 4/02; H04W 24/10; G01S 19/13; H04W 64/00

(52) U.S. Cl. CPC H04W 4/025; H04W 64/00; H04W 24/10; G01S 19/13

(57) ABSTRACT

An object distance determination system for measuring the linear distance between two objects. The object distance determination system comprises a smartphone configured as a base station in the preferred embodiment and a reference device. Through a reference distance determination software application, the reference device transmits GPS positioning information, along with a unique identifier associated with it over a wireless networking interface to the base station. The base station includes an object distance determination software application that configures it to retrieve its positioning information and receive over a wireless networking interface identification and positioning information from the reference device. Using this information, the object distance determination software application calculates the linear distance from the reference device to the base station and causes the display of the reference device and the calculated linear distance on the display of the base station.

### BACKGROUND OF THE INVENTION

1. Field of the Invention

This invention relates generally to a positioning system and, more particularly, to an object distance determination system employing a GPS enabled accessory and a GPS enable tracking transceiver.

2. Description of the Prior Art

The use of conventional measuring tools, such as a tape measure or measuring wheel, to measure distances is well known. A problem which still exists, however, is that tools, such as tape measures and measuring wheels are generally best suited for relatively smaller distances and are prone to inaccuracies when measuring relatively larger distances. Compounding this issue is the fact that conventional tools that are more suited to measure larger distances are often impractical for measuring small distances. Thus, there remains a need for an object distance determination system that enables a user to measure accurately measure both smaller distances and larger distances. It would be helpful if such an object distance determination system employed satellite positioning technology to for identifying reference points in measurements. It would be additionally desirable for such an object distance determination system to be operable through a software application on a GPS enabled computer, such as a smartphone.

The Applicant's invention described herein provides for an object distance determination system adapted to allow a user to measure the distance between two reference points that have been associated with the components of the system. The primary components in Applicant's object distance determination system are a base station and a reference device. When in operation, the object distance determination system provides more effective and efficient measurements between two objects at that have been selectively positioned at desired reference points. As a result, many of the limitations imposed by prior art structures are removed.

### SUMMARY OF THE INVENTION

An object distance determination system for measuring the linear distance between two objects. The object distance determination system comprises a smartphone configured as a base station in the preferred embodiment and a reference device. Through a reference distance determination software application, the reference device transmits GPS positioning information, along with a unique identifier associated with it over a wireless networking interface to the base station. The base station includes an object distance determination software application that configures it to retrieve its positioning information and receive over a wireless networking interface identification and positioning information from the reference device. Using this information, the object distance determination software application calculates the linear distance from the reference device to the base station and causes the display of the reference device and the calculated linear distance on the display of the base station.

It is an object of this invention to provide an object distance determination system that enables a user to measure accurately measure both smaller distances and larger distances.

It is another object of this invention to provide an object distance determination system that employs satellite positioning technology to for identifying reference points in measurements.

It is yet another object of this invention to provide an object distance determination system to be operable through a software application on a GPS enabled computer, such as a smartphone.

These and other objects will be apparent to one of skill in the art.

### BRIEF DESCRIPTION OF THE DRAWINGS

FIG. 1 is a front elevational view of a base station of an object distance determination system built in accordance with the present invention.

FIG. 2A is a front elevational view of a reference device of an object distance determination system built in accordance with the present invention.

FIG. 2B is a side elevational view of a reference device of an object distance determination system built in accordance with the present invention.

FIG. 3 is a side perspective view of a reference device of an object distance determination system built in accordance with an alternate embodiment of the present invention.

### DETAILED DESCRIPTION OF THE INVENTION

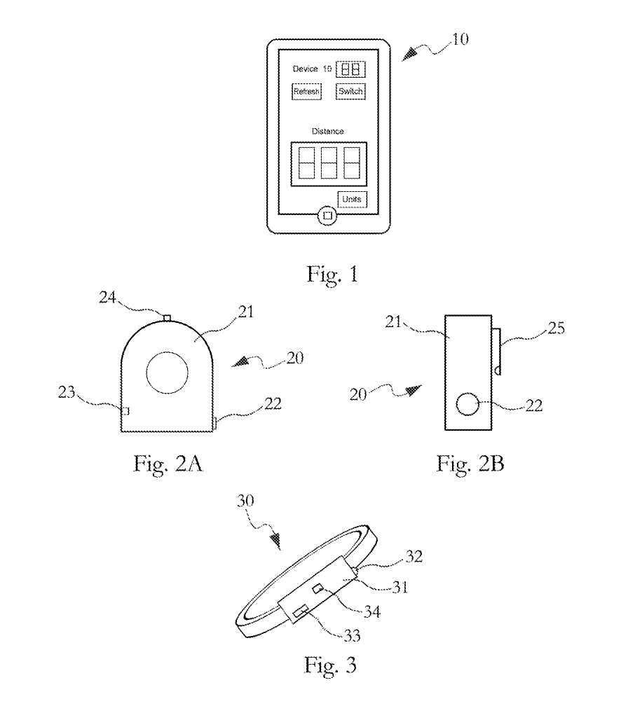

Referring now to the drawings and in particular FIGS. 1, 2A, and 2B, an object distance determination system includes a base station 10 and a reference device 20. The base station 10 defines a computer system or mobile computer, such as a smartphone in the preferred embodiment, that includes a controller, non-volatile memory, a display, a GPS receiver, a wireless networking interface, an input interface, and a power source, with the controller configured to execute instructions from software programs stored in the memory. In the preferred embodiment, the base station's 10 wireless networking interface defines a local area network wireless (Wi-Fi in the preferred embodiment) antenna and a personal area network wireless (Bluetooth in the preferred embodiment) antenna. The reference device 20 defines a device housing 21 that includes a conventional flash light 22, a conventional charging port 23 (a USB interface in the preferred embodiment), a momentary connect button 24, and an attachment clip 25. The device housing 21 houses the operative electronic components, including a controller, non-volatile memory, a GPS receiver, a wireless networking interface, and a power source, with the controller configured to execute instructions from software programs stored in the memory. In the preferred embodiment, the reference device's 20 wireless networking interface defines a local area network wireless (Wi-Fi in the preferred embodiment) antenna and a personal area network wireless (Bluetooth in the preferred embodiment) antenna. It is appreciated that the connect button 24 is operative to cause the reference device 20 to initiate a bonding authentication process to form a Bluetooth connection connect to a wireless and, if no device is available to pair with, connect to a wireless LAN.

The reference device 20 includes a reference distance determination software application loaded into its memory. The reference distance determination software application allows the reference device to retrieve positioning information related to its present location from the reference device's 20 GPS receiver and transmit this positioning information, along with a unique identifier associated with the reference device 20, through the wireless networking interface. Through its wireless networking interface, the reference device communicates its current position to a selected base station 10 through over a wireless LAN, either directly on the same LAN or over the Internet between discrete wireless LANs, or to a paired base station 10 through an Bluetooth connection, depending on what type of connection is available. In the preferred embodiment, the reference device 20 seeks to utilize a Bluetooth connection first.

A smartphone or other computer is configured to operate as a base station 10 in accordance with the present invention through an object distance determination software application loaded in its memory. The object distance determination software application is operative to enable the base station 10 to retrieve positioning information related to its present location from the base station's 10 GPS receiver, receive over its wireless networking interface a transmission from a reference device 20 that identifies the reference device 20 and positioning information concerning the identified reference device's 20 present location. Using this information, the object distance determination software application calculates the linear distance from the reference device 20 to the base station 10 and causes the display of the reference device 20 and the calculated linear distance on the display of the base station 10.

It is contemplated that a single base station 10 may be used to measure the distance between one reference device 20 or a plurality of reference devices 20.

Referring now to FIG. 3, in an alternate embodiment of the present invention, the reference device 30 defines a wearable bracelet with an electronics housing 31 that includes a conventional flash light 32, a conventional charging port 33 (a USB interface in the preferred embodiment), a momentary connect button 34, as well as all of the operative electronic components that enable the reference device 30 to operate as the reference device described in FIGS. 2A and 2B.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An object distance determination system, comprising:
a base station having a controller, non-volatile memory, a satellite positioning receiver, a wireless networking interface, and a power source, wherein the controller configured to execute instructions from software programs stored in the memory;
a reference device defining a device housing that includes a controller, non-volatile memory, a satellite positioning receiver, a wireless networking interface, and a power source, wherein the controller configured to execute instructions from software programs stored in the memory;
said reference device configured to retrieve reference positioning information related to its present geographic location from the reference device's satellite positioning receiver and transmit the reference positioning information, along with a unique reference identifier associated with the reference device, through its wireless networking interface; and
said base station configured to retrieve base positioning information related to its present geographic location from the base station's satellite positioning receiver, receive over its wireless networking interface a transmission from said reference device that identifies the reference device and provides reference positioning information, and calculate the linear distance between the geographic location defined by the reference positioning information and the geographic location defined by the base positioning information.

2. The object distance determination system of claim 1, wherein the reference device additionally includes a display and additionally configured to cause the display of the calculated linear distance on said display.

3. The object distance determination system of claim 1, wherein said reference device additionally includes a conventional flash light.

4. The object distance determination system of claim 1, wherein said reference device additionally includes a conventional charging port.

5. The object distance determination system of claim 4, wherein said conventional charging port defines a USB interface.

6. The object distance determination system of claim 1, wherein said reference device additionally includes a momentary connect button.

7. The object distance determination system of claim 1, wherein said reference device additionally includes an attachment clip.

8. The object distance determination system of claim 1, wherein said reference device is wearable.

9. The object distance determination system of claim 1, wherein the base station's satellite positioning receiver and the reference device's satellite positioning receiver each define a GPS receiver.

10. The object distance determination system of claim 1, wherein said wireless networking interface defines at least one of Bluetooth antenna and Wi-Fi antenna.

11. The object distance determination system of claim 1, wherein said wireless networking interface defines a Bluetooth antenna and a Wi-Fi antenna configured to operate if a Bluetooth connection is not established.
